(19) United States
(12) Patent Application Publication
(10) Pub. No.: US 2026/0199948 A1
(43) Pub. Date: Jul. 16, 2026

(54) AUTOMATED SPHERE PLATE PRESSING METHOD

(71) Applicant: CB&I STS Delaware LLC, The Woodlands, TX (US)

(72) Inventor: David CREECH, Glen Ellyn, IL (US)

(21) Appl. No.: 19/133,657

(22) PCT Filed: Nov. 28, 2023
(86) PCT No.: PCT/US2023/081426

§ 371 Date: May 28, 2025

Related U.S. Application Data
(60) Provisional application No. 63/428,275, filed on Nov. 28, 2022.

(51) Int. Cl. B21D 5/00; B21D 11/22; B21D 19/00; B21D 51/08; B23K 7/00; B23K 10/00

(52) U.S. Cl. CPC B21D 5/006; B21D 5/002; B21D 5/004; B21D 11/22; B21D 19/005; B21D 51/08; B23K 7/001; B23K 7/002; B23K 10/003

(57) ABSTRACT

The present disclosure generally relates to a method and apparatus of forming a plate. The method of forming the plate includes providing the plate to a press of an assembly system. The plate is formed with the press. The plate is transported to an inspection station of the assembly system and inspected. The plate is transported to a trimming station of the assembly system. The plate is cut using a trimming head of the trimming station and inspected at the trimming station. The controller stores instructions that, when executed by a processor, causes the system to form a plate.

### BACKGROUND

### Field

Embodiments of the present disclosure generally relate to methods of forming segmented sphere plates, such as those used for forming spherical storage tanks.

### Description of the Related Art

Conventional methods of forming spherical plates are cumbersome, time consuming, and require excessive man-hours to complete.

Therefore, there is a need for improved methods of forming segmented plates.

### SUMMARY

The present disclosure generally relates to methods of forming segmented sphere plates, such as those used for forming spherical storage tanks.

In one embodiment, an assembly system is disclosed. The assembly system includes a press, a first manipulator, a second manipulator, one or more manipulator guide rails, an inspection station, and a trimming station. The press includes a base portion, a top portion, one or more vertical supports, a ram; and a manipulation crucible. The first manipulator and the second manipulator support a plate within the press. The one or more manipulator guide rails are coupled to the manipulator guide rails. The inspection station includes an inspection platform and one or more inspection platform guide rails. The trimming station includes one or more trimming arm supports, a trimming stage, and a trimming arm supported by the one or more trimming arm supports. The trimming arm includes a trimming head.

In another embodiment, a controller of an assembly system is disclosed. The controller stores instructions that, when executed by a processor, causes the system to form a plate within a press by moving the plate between a ram and a manipulation crucible and stroking the ram towards the manipulation crucible. The controller transports the plate to an inspection station and inspects the plate at the inspection station. The controller cuts the plate at a trimming station. The controller receives sensor readings from sensors in the assembly system to continuously monitor the forming, inspecting, and trimming of the plate.

In yet another embodiment, a method is disclosed. The method includes providing a plate to a press of an assembly system. The plate is formed with the press. The plate is transported to an inspection station of the assembly system and inspected. The plate is transported to a trimming station of the assembly system. The plate is cut using a trimming head of the trimming station and inspected at the trimming station.

It is contemplated that elements and features of one embodiment may be beneficially incorporated in other embodiments without further recitation.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 illustrates an assembly system, according to embodiments of the disclosure.

FIG. 2A illustrates a perspective view of the press, according to embodiments of the disclosure.

FIG. 2B illustrates a front view of the press, according to embodiments of the disclosure.

FIG. 2C illustrates a side view of the press, according to embodiments of the disclosure.

FIG. 3A illustrates a front view of the inspection platform of the inspection station, according to embodiments of the disclosure.

FIG. 3B illustrates a top view of the inspection platform of the inspection station, according to embodiments of the disclosure.

FIG. 3C illustrates a side view of the inspection platform of the inspection station, according to embodiments of the disclosure.

FIG. 4 illustrates the trimming station, according to embodiments of the disclosure.

FIG. 5 illustrates a control schematic for use with the assembly system of FIG. 1, according to embodiments of the disclosure.

FIG. 6 illustrates a method of processing a plate, according to embodiments of the disclosure.

### DETAILED DESCRIPTION

The present disclosure generally relates to an apparatus and methods of forming segmented plates, such as those used for forming spherical storage tanks. The apparatus includes an assembly system including a press, a first manipulator, a second manipulator, one or more manipulator guide rails, an inspection station, and a trimming station. The press includes a base portion, a top portion, one or more vertical supports, a ram; and a manipulation crucible. The first manipulator and the second manipulator support a plate within the press. The one or more manipulator guide rails are coupled to the manipulator guide rails. The inspection station includes an inspection platform and one or more inspection platform guide rails. The trimming station includes one or more trimming arm supports, a trimming stage, and a trimming arm supported by the one or more trimming arm supports. The trimming arm includes a trimming head. A method of forming the plate includes providing the plate to a press of an assembly system. The plate is formed with the press. The plate is transported to an inspection station of the assembly system and inspected. The plate is transported to a trimming station of the assembly system. The plate is cut using a trimming head of the trimming station and inspected at the trimming station. The controller stores instructions that, when executed by a processor, causes the system to form a plate.

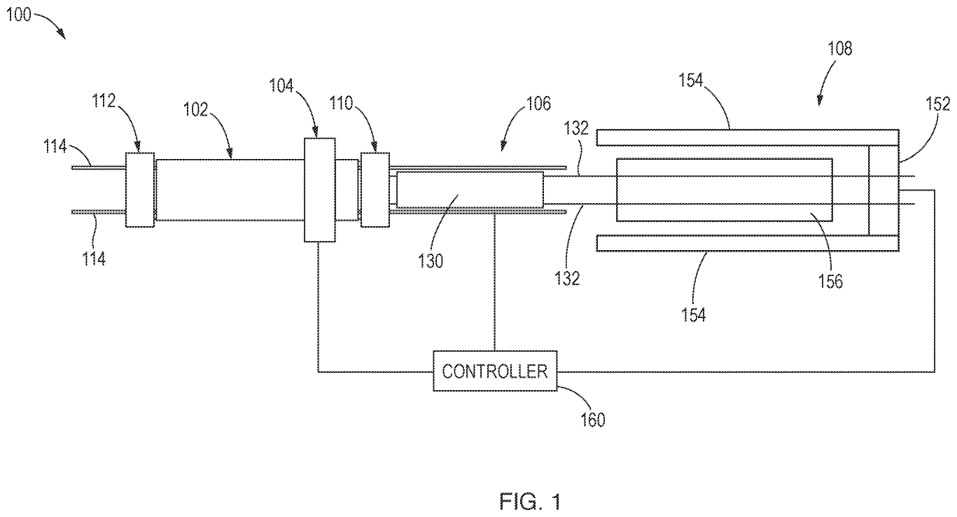

FIG. 1 illustrates an assembly system 100. In some embodiments, the assembly system 100 is configured to form a plate 102 into a spherical shape as a component to a storage tank or vessel. The assembly system 100 includes a press 104, an inspection station 106, and a trimming station 108. The plate 102 is supported within the press 104 by a first manipulator 110 and a second manipulator 112. The first manipulator 110 and second manipulator 112 are mounted on manipulator guide rails 114. The first manipulator 110 (such as a gripper, retention member, or the like) and the second manipulator 112 (such as a gripper, retention member, or the like) are configured to move in transversely and longitudinally via the manipulator guide rails 114 within the press 104. The movement of the first manipulator 110 and the second manipulator 112 within the press 104 moves the plate 102 within the press 104 in order to form the plate 102.

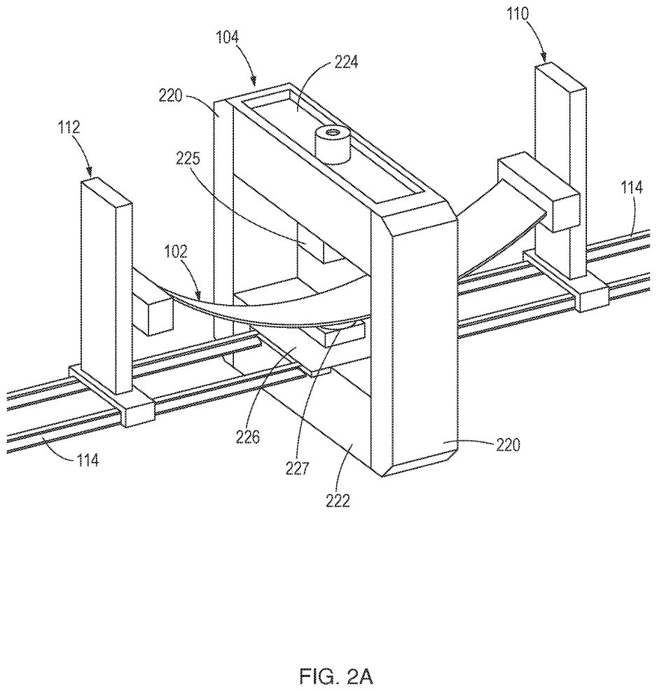

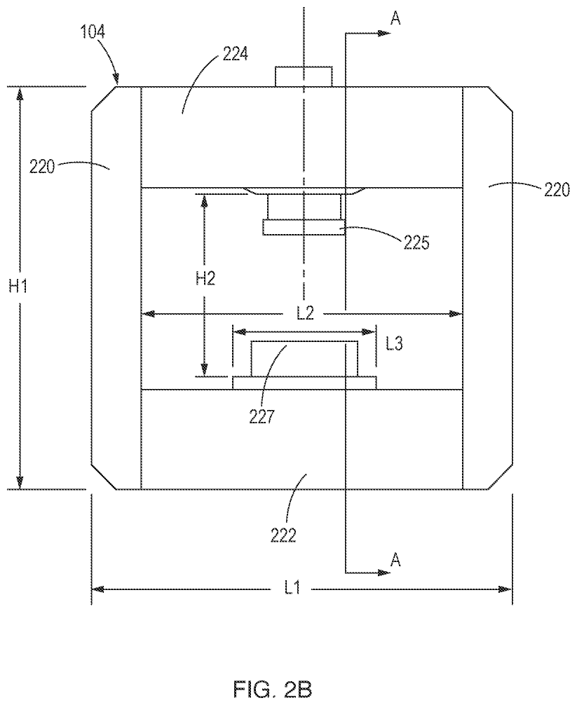

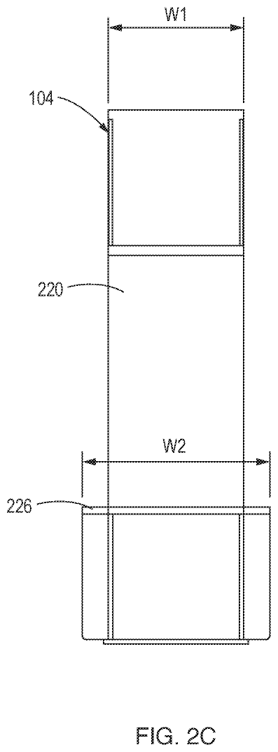

FIG. 2A-2C illustrate the press 104. FIG. 2A illustrates a perspective view of the press 104. FIG. 2B illustrates a front view of the press 104. FIG. 2C illustrates a side view of the press 104. The press 104 includes vertical supports 220, a base portion 222, a top portion 224, a ram 225, a base plate 226, and manipulation crucible 227. The vertical supports 220 span between the base portion 222 and the top portion 224. The manipulation crucible 227 is mounted to the base plate 226. The base plate 226 is disposed on the base portion 222 of the press 104. The press 104 has a height H1 of about 8000 mm to about 9000 mm. The press 104 has a length L1 of about 6000 mm to about 7000 mm. A second height H2 from a top surface of the base portion 222 to a bottom surface of the top portion 224 is from about 3500 mm to about 4500 mm A second length L2 from the inner surface of a vertical support 220 to the inner surface of the other vertical support 220 is about 4000 mm to about 5000 mm. The press 104 has a width W1 of about to 2000 mm about 3000 mm The base plate 226 has a third length L3 of about 3000 mm to about 4000 mm and a second width W2 of about 2500 mm to about 3500 mm.

As the first manipulator 110 and second manipulator 112 move the plate 102 within the press 104, the ram 225 manipulates the plate 102 within the manipulation crucible 227. In some examples, the first manipulator 110 and the second manipulator 112 each include grooves for receiving and retaining the plate 102 therein. The ram 225 is configured to stroke downward towards the manipulation crucible 227 to form the plate 102. The ram 225 then strokes upward to release the plate 102 and allow the first manipulator 110 and the second manipulator 112 to move the plate 102 within the press 104 to continue forming the plate 102 into using another downward stroke of the ram 225. The press 104 is configured to repeat this process until the plate 102 is formed.

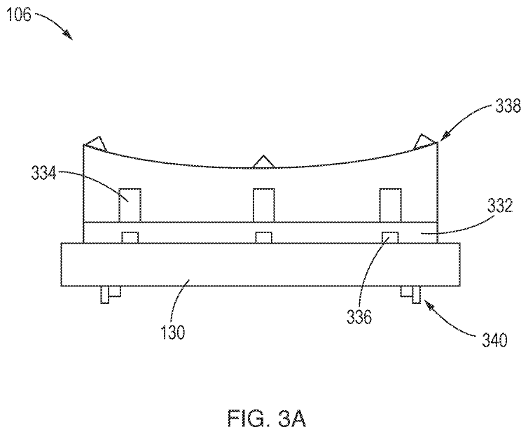

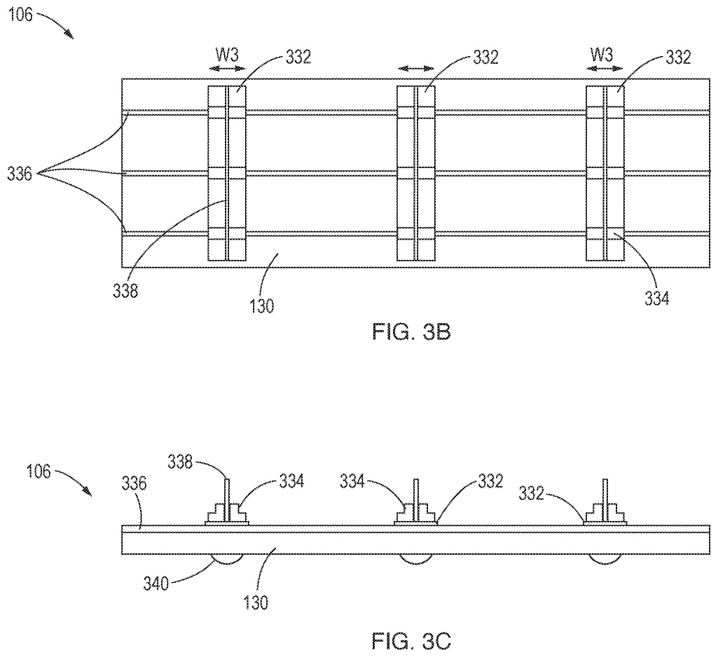

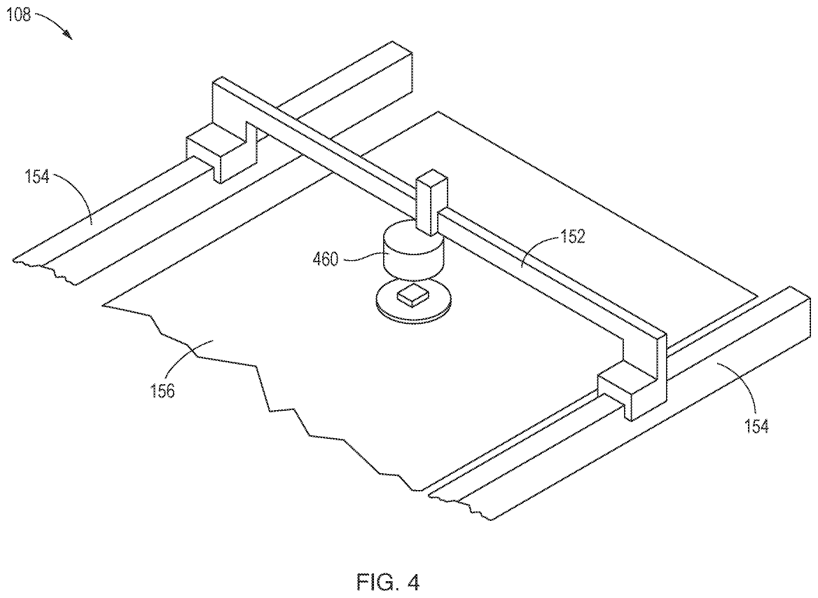

FIGS. 3A-3C illustrate an inspection platform 130 of the inspection station 106. FIG. 3A illustrates a front view of the inspection platform 130 of the inspection station 106. FIG. 3B illustrates a top view of the inspection platform 130 of the inspection station 106. FIG. 3C illustrates a side view of the inspection platform 130 of the inspection station 106. The inspection station 106 includes the inspection platform 130 and inspection platform guide rails 132. The inspection platform 130 includes baseplates 332, a support gusset 334, adjustment rails 336, supports 338, and a plurality of wheels 340. The supports 338 of the inspection platform 130 can be adjusted using the adjustment rails 336. The baseplates 332 may be moved along the adjustment rails 336 to adjust the predetermined specifications and tolerances of the inspection platform 130. The adjustment rails 336 are coupled to the support gussets 334. The support gussets 334 are configured to be coupled to and support the supports 338 when the supports 338 are supporting the plate 102.

The plate 102 is transported from the press 104 to the inspection station 106 along the manipulator guide rails 114. The plate 102 is disposed on the inspection platform 130, in particular, the plate 102 is disposed on the supports 338. In some embodiments, the manipulator guide rails are positioned such that the first manipulator 110 can pass over the inspection platform 130 to facilitate the disposing of the plate 102 onto the inspection platform 130. The inspection platform 130 is configured to determine if the plate 102 has been formed within the predetermined specifications and tolerances. The predetermined specifications and tolerances of the plate 102 are determined, in some embodiments, by ensuring that the plate 102 is in contact with each of the supports 338. As shown in FIGS. 3A-3C, the inspection platform 130 includes 9 supports 338, though more or less supports 338 are contemplated by the disclosure. In order to achieve the desired specifications for a radius of the plate 102, for example, the plate 102 should contact each of the nine supports 338. If the plate 102 is not within the predetermined specifications and tolerances, the plate 102 is transported back to the press 104 to further form the plate 102. If the plate 102 is within the predetermined specifications and tolerances, the inspection platform 130 is transported to the trimming station 108 along the inspection platform guide rails 132.

FIG. 4 illustrates the trimming station 108. The trimming station 108 includes a trimming arm 152, one or more trimming arm supports 154, and a trimming stage 156. The trimming arm 152 includes a trimming head 460. The trimming arm 152 may be configured to be controlled by a computer numerically controlled (CNC) device. The trimming head 460 is configured to cut the plate 102 in the X-, Y-, and Z-axis and to trim and bevel edges of the plate 102. The trimming head 460 may be a high definition plasma cutting torch, an oxyfuel cutting torch, or other suitable cutting torch depending on the plate material and thickness.

The trimming station 108 is configured to measure the accuracy of the cuts performed on the plate 102. If the cuts performed on the plate 102 are not within the predetermined specifications and tolerances, the plate 102 is further cut using the trimming head 460. If the plate 102 is within the predetermined specifications and tolerances, the plate 102 is removed from the assembly system 100.

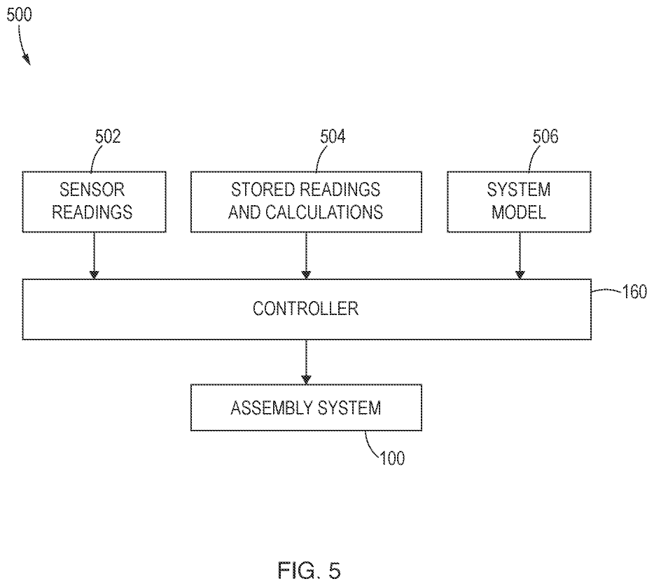

FIG. 5 illustrates a control schematic 500 for use with the assembly system 100 of FIG. 1. The controller 160 is configured to receive data or input as sensor readings 502 from each of the press 104, the inspection station 106, and the trimming station 108. The controller 160 is equipped with or in communication with a system model 506 of the assembly system 100. The system model 506 includes a specifications and tolerances model. The system model 506 is a program configured to estimate the number and pressure of strokes of the ram 225, the distance and direction of the movement of the plate 102 within the press 104, the specifications and tolerances of the plate 102 in the inspection station 106, and cuts performed in the trimming station 108. The controller 120 is further configured to store readings and calculations 504.

The readings and calculations 504 include previous sensor readings 502 as well as any other previous sensor readings within the assembly system 100. The readings and calculations 504 further include the stored calculated values from after the sensor readings 502 are measured by the controller 160 and run through the system model 506. Therefore, the controller 160 is configured to both retrieve stored readings and calculations 504 as well as save readings and calculations 504 for future use. Maintaining previous readings and calculations enables the controller 160 to adjust the system model 506 over time to increase the efficiency and accuracy of the assembly system 100. The controller 160 is further configured to adjust the assembly process in order to comply with the specifications and tolerances model by continuously monitoring the processing of the plate 102.

In embodiments described herein, the controller 160 includes a programmable central processing unit (CPU) that is operated with a memory and a mass storage device, an input control unit, and a display unit (not shown). The controller 160 monitors the plate 102 forming, inspection, and trimming. Support circuits are coupled to the CPU for supporting the processor in a conventional manner. In some embodiments, the controller 160 includes multiple controllers 160, such that the stored readings and calculations 504 and the system model 506 are stored within a separate controller from the controller 160 which operates the assembly system 100. In other embodiments, all of the system model 506 and the stored readings and calculations 504 are saved within the controller 160.

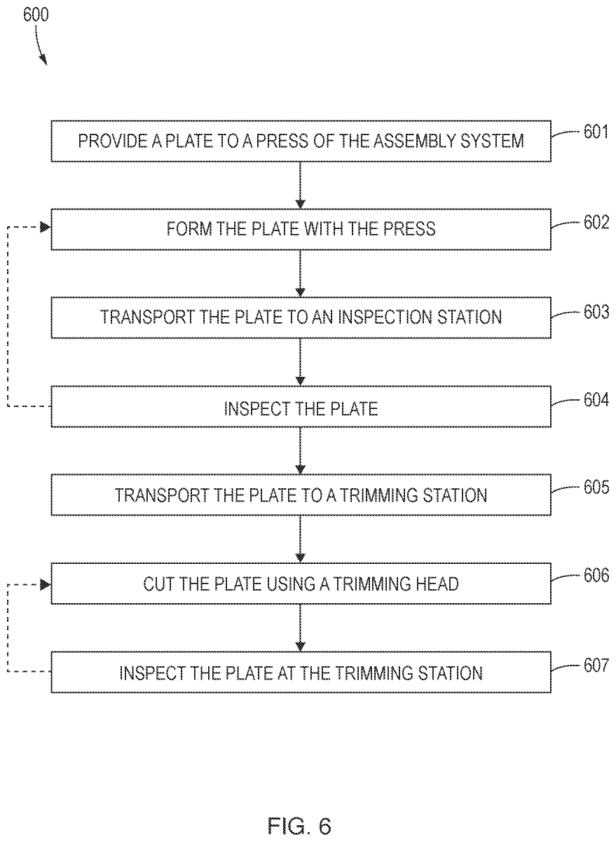

FIG. 6 illustrates a method 600 of processing a plate 102. At operation 601, the plate 102 is provided to a press 104 of the assembly system 100. The plate 102 is supported in the press 104 by a first manipulator 110 and a second manipulator 112. The press 104 includes a ram 225 and a manipulation crucible 227.

At operation 602, the press 104 forms the plate 102. The ram 225 of the press 104 is stroked downward toward the manipulation crucible 227 with the plate 102 disposed in between the ram 225 and the manipulation crucible 227. The ram 225 is stroked upward away from the manipulation crucible to enable to the first manipulator 110 and second manipulator 112 to move the plate 102 within the press 104 for additional forming. The plate 102 is repeatedly pressed between the ram 225 and the manipulation crucible 227 until the plate 102 is formed.

At operation 603, the plate 102 is transported to an inspection station 106. The plate 102 is disposed on an inspection platform 130. The inspection platform 130 includes a plurality of supports 338.

At operation 604, the plate 102 is inspected. The inspection platform 130 is configured to determine if the plate 102 has been formed within the predetermined specifications and tolerances. The predetermined specifications and tolerances of the plate 102 are determined, in some embodiments, by ensuring that the plate 102 is in contact with each of the supports 338. If the plate 102 is not within the predetermined specifications and tolerances, the plate 102 is transported back to the press 104 to repeat operation 602. If the plate 102 is within the predetermined specifications and tolerances, the method 600 proceeds to operation 605.

At operation 605, the inspection platform 130 is transported to the trimming station 108. At operation 606, the plate 102 is cut by a trimming head 460 of a trimming arm 152. The trimming head 460 is configured to cut the plate 102 in the X-, Y-, and Z-axis and to trim and bevel edges of the plate 102. The trimming head 460 may be a high definition plasma cutting torch, an oxyfuel cutting torch, or other suitable cutting torch depending on the plate material and thickness.

At operation 607, the plate 102 is inspected at the trimming station 108. The trimming station 108 is configured to measure the accuracy of the cuts performed on the plate 102. If the cuts performed on the plate 102 are not within the predetermined specifications and tolerances, the plate 102 is further cut using the trimming head 460 according to operation 606. If the plate 102 is within the predetermined specifications and tolerances, the plate 102 is removed from the assembly system 100 for further processing.

In summary, a method and apparatus of forming a plate are provided. The method of forming the plate includes providing the plate to a press of an assembly system. The plate is formed with the press. The plate is transported to an inspection station of the assembly system and inspected. The plate is transported to a trimming station of the assembly system. The plate is cut using a trimming head of the trimming station and inspected at the trimming station. The controller stores instructions that, when executed by a processor, causes the system to form a plate.

While the foregoing is directed to embodiments of the present disclosure, other and further embodiments of the disclosure may be devised without departing from the basic scope thereof, and the scope thereof is determined by the claims that follow.

What is claimed is:

1. A method of processing a plate, comprising:
providing a plate to a press of an assembly system;
forming the plate with the press;
transporting the plate to an inspection station of the assembly system;
inspecting the plate;
transporting the plate to a trimming station of the assembly system;
cutting the plate using a trimming head of the trimming station; and
inspecting the plate at the trimming station.

2. The method of claim 1, further comprising determining if the plate has been formed within predetermined specifications and tolerances when inspecting the plate at the inspecting station.

3. The method of claim 2, further comprising returning the plate to the press if the plate has not been formed within the predetermined specifications and tolerances.

4. The method of claim 3, further comprising additionally forming the plate if the plate has not been formed within the predetermined specifications and tolerances.

5. The method of claim 1, wherein the trimming head comprises a plasma cutting torch or an oxyfuel cutting torch.

6. The method of claim 1, further comprising determining if the plate has been cut within the predetermined specifications and tolerances when inspecting the plate at the trimming station.

7. The method of claim 6, further comprising additionally cutting the plate if the plate has not been cut within the predetermined specifications and tolerances.

8. An assembly system, comprising:
a press, comprising:
a base portion;
a top portion;
one or more vertical supports;
a ram; and
a manipulation crucible;
a first manipulator;
a second manipulator, wherein the first manipulator and the second manipulator support a plate within the press;
one or more manipulator guide rails wherein the first manipulator and second manipulator are coupled to the manipulator guide rails;
an inspection station, comprising:
an inspection platform; and
one or more inspection platform guide rails;
a trimming station, comprising:
one or more trimming arm supports;
a trimming stage; and
a trimming arm supported by the one or more trimming arm supports,
the trimming arm comprising a trimming head.

9. The assembly system of claim 8, wherein the trimming head comprises a high definition plasma cutting torch or an oxyfuel cutting torch.

10. The assembly system of claim 8, further comprising the manipulation crucible disposed on a base plate, wherein the base plate is disposed on the base portion of the press.

11. The assembly system of claim 8, wherein the inspection platform further comprises:
one or more baseplates;
one or more support gussets coupled to the baseplates;
one or more adjustment rails;
one or more supports coupled to the one or more support gussets; and
a plurality of wheels.

12. The assembly system of claim 11, wherein the supports are configured to support the plate.

13. The assembly system of claim 8, further comprising a controller configured to receive sensor readings from the assembly system.

14. The assembly system of claim 13, wherein the controller compares the sensor readings from the assembly system to a system model including a specifications and tolerances model to determine adjustments to the assembly system.

15. A controller of an assembly system storing instructions that, when executed by a processor, causes the system to:
form a plate within a press by moving the plate between a ram and a manipulation crucible and stroking the ram towards the manipulation crucible;
transport the plate to an inspection station;
inspect the plate at the inspection station; and
cut the plate at a trimming station, wherein the controller receives sensor readings from sensors in the assembly system to continuously monitor the forming, inspecting, and trimming of the plate.

16. The controller of claim 15, the controller further causing the assembly system compare the forming, inspecting, and cutting of the plate to a system model including a specifications and tolerances model.

17. The controller of claim 15, the controller further adjusting the forming and cutting in response to sensor readings of the assembly system.

18. The controller of claim 15, the controller further storing sensor readings in a memory.

19. The controller of claim 15, the controller further causing the cutting in a X-, Y-, and Z-axis and to trim and bevel edges of the plate.

20. The controller of claim 15, the controller further causing repeated pressing of the plate between the ram and the manipulation crucible.
